(19) United States
(12) Patent Application Publication
(10) Pub. No.: US 2026/0362535 A1
(43) Pub. Date: Nov. 12, 2026

(54) UE ON-DEMAND MEASUREMENT FOR NETWORK ENERGY SAVING

(71) Applicant: Apple Inc., Cupertino, CA (US)

(72) Inventors: Peng Cheng, Beijing (CN); Naveen Kumar R Palle Venkata, San Diego, CA (US); Ralf Rossbach, Munich (DE); Fangli Xu, Beijing (CN); Ping-Heng Kuo, London (GB); Haijing Hu, Los Gratos, CA (US); Sigen Ye, San Diego, CA (US); Alexander Sirotkin, Hod Hasharon (IL)

(21) Appl. No.: 18/997,016

(22) PCT Filed: Jun. 15, 2023
(86) PCT No.: PCT/US23/25379

§ 371 Date: Jan. 18, 2025

Related U.S. Application Data
(60) Provisional application No. 63/395,890, filed on Aug. 8, 2022.

(51) Int. Cl. H04W 76/27; H04B 7/06; H04W 36/00

(52) U.S. Cl. CPC H04W 76/27; H04B 7/0626; H04W 36/00692

(57) ABSTRACT

Techniques, described herein, include solutions for saving network energy using assistance information from a user equipment (UE). In one aspect, during operation, the UE performs a Reference Signal (RS) measurement using a first RS received from a Base Station (BS). The UE then determines whether the RS measurement is sufficient based on UE needs and previously received network configuration. In a Radio Resource Control (RRC) connected state, the UE may transmit an RS request to the BS to request a second RS if the RS measurement of the first RS is determined as insufficient. The the UE may receive the second RS from the BS and perform a measurement using the second RS. The second RS may be an on-demand RS dedicated to UE or an adapted RS replacing the first RS.

### FIELD

This disclosure relates to wireless communication networks including techniques for conserving power within wireless communication networks.

### BACKGROUND

Wireless communication networks may include user equipments (UEs), base stations (BSs), and/or other types of wireless devices capable of communicating with one another. During operation, a UE may measure signal quality of a serving cell and/or its neighboring cells periodically or triggered by certain condition. The UE measurements may be used to determine whether some procedures, such as handover to another cell or addition of another carrier component, are needed to improve the quality of signal connection or to increase the bit rate.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a schematic diagram illustrating signaling between a user equipment (UE) and a base station (BS) for on-demand RS measurement based on a Reference Signal (RS) request from the UE in accordance with some aspects of the disclosure.

FIG. 2 is a schematic diagram illustrating additional or alternative signaling details between a UE and a BS for on-demand RS measurement based on an RS request from the UE in accordance with some additional aspects of the disclosure.

FIGS. 3A-3C are schematic diagrams illustrating on-demand RS related MAC-CEs in accordance with some aspects of the disclosure.

FIG. 4 is a diagram illustrating an example of an RS request information element in accordance with some aspects of the disclosure.

FIG. 5 is a diagram illustrating an example of an RS configuration in accordance with some aspects of the disclosure.

FIG. 6 is a block diagram illustrating a wireless network including a UE and a BS for on-demand RS measurement based on an RS request from the UE in accordance with some aspects of the disclosure.

FIG. 7 is a block diagram illustrating a device that can be employed in accordance with some aspects of the present disclosure.

FIG. 8 is a block diagram illustrating baseband circuitry that can be employed in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

One aspect of the continuing optimization to a wireless network is to reduce energy consumption of the network to achieve more efficient operation. Energy consumption can depend on many factors, including pattern, length, periodicity, and strength of transmitted reference signal (RS). During operation, a user equipment (UE) needs to perform various measurements on the RS to assess channel and signal quality of a serving cell and/or its neighboring cells. Such measurements may include reference signal received power (RSRP) measurement, reference signal received quality (RSRQ) measurement, signal to interference & noise ratio (SINR) measurements, or the like. Longer and more frequently repeated RS enhances UE measurements, but will result in higher power consumption. To improve network energy saving and achieve more efficient operation, it is desired to study finer granularity adaption of RS transmission based on the needs of UE and UE operations. As such, a base station (BS) may transmit a sparse RS when possible and adapt to a more intensive RS when a more rigorous UE need arrives.

As an example, introduced in 5G, synchronization signal/physical broadcast channel (SS/PBCH) blocks (SSBs) may be used as such an RS for the UE measurements. Multiple SSBs are included in an SSB burst to address the requirements of beamforming and beam sweeping. Each SSB of the SSB burst is allocated to a beam, and each beam transmits its SSB with different allocated time resources. The SSB burst may be transmitted repeatedly from the BS to the UE within a time window that is scheduled periodically. Periodicity and duration of the time window are both defined by a SSB measurement timing configuration (SMTC). For example, more frequent SSB transmission will result in higher power consumption. Depending on the type of beamforming used for the SSBs, energy consumption will also vary. For example, using a larger number of narrow beams will result in higher energy consumption.

The BS may initially transmit SSB with a long periodicity and a smaller number of wide beams to not consume excessive energy. This initial SSB pattern may meet needs of empty or low loads. However, when a more demanding service arrives, such as ultra-reliable low latency communications (URLLC) that is latency sensitive, the latency requirement may not be satisfied when the UE needs to wait for the long periodicity for the next SSB to arrive. Thus, an additional or adapted SSB may be desired when the URLLC arrives.

Accordingly, the present disclosure relates to techniques to add or adapt RS with support or feedback from a UE, in order to achieve optimal network energy saving. In some aspects, the UE performs an RS measurement using a first RS received from a BS. The UE may be configured to generate assistance information based on the performed RS measurement. Upon a determination of a more demanding service or an insufficiency of current measurement, the UE may transmit the assistance information to the BS to request on-demand RS. The assistance information may be transmitted in a Radio Resource Control (RRC) connected state. The assistance information may comprise an RS request included in a UE Assistance Information (UAI) message or a MAC Control Element (MAC-CE). The RS request may include parameters of an on-demand RS the UE prefers, such as one or more of an RS type, an RS occurrence pattern, and an RS duration. As disclosed in more detail below, after the on-demand RS is activated, the BS can dynamically add or adapt its RS transmission based on the activation of the on-demand RS.

For example, the BS may initially transmit SSB with a long periodicity and a smaller number of wide beams to not consume excessive energy. This initial SSB pattern may meet needs of empty or low loads. However, when a more demanding service (e.g., URLLC) arrives, a different SSB pattern may be desired. The assistance information can indicate such a need from the UE. Depending on the assistance information received from the UE, the network may modify the SSB pattern, such as SSB periodicity or number of SSB beams to meet more rigorous measurement needs. Thereby, energy consumption of the network transmission can be more accurately controlled and reduced compared to using a static or more coarsely adjusted SSB pattern.

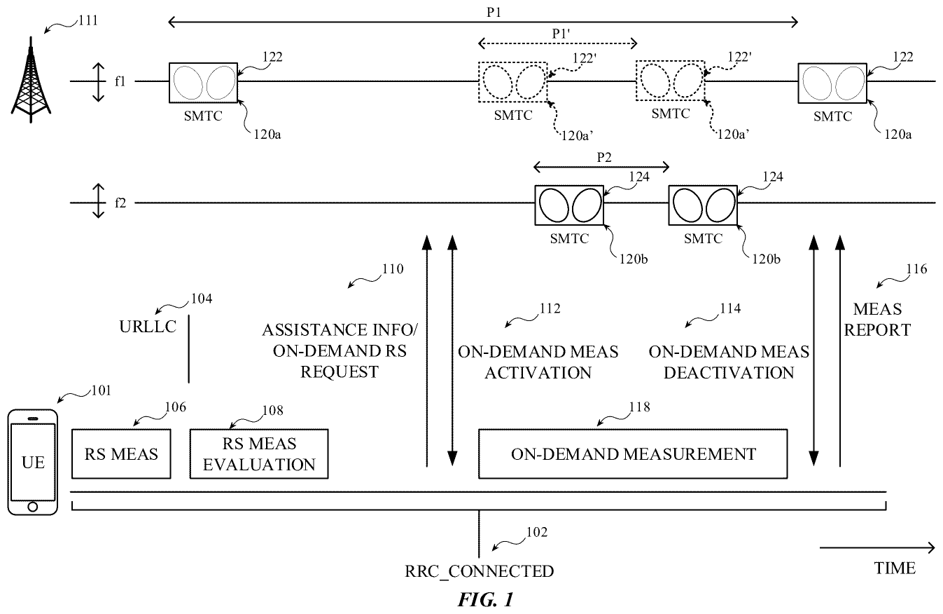

FIG. 1 illustrates a schematic diagram illustrating signaling between a UE 101 and a BS 111 for on-demand RS measurement based on an RS request from the UE in accordance with some aspects of the disclosure. In one aspect, the schematic diagram may be understood as presented along a time line, but various acts could also happen in a different timing order. In this example, the UE 101 may stay in an RRC connected state as shown by 102. The UE 101 may perform a (pre)configured RS measurement at act 106 using a first RS received from the BS 111. The RS measurement may be for regular signal quality monitor and/or for cell selection or reselection. The RS measurements may include measuring RSRP, RSRQ, or SINR of the cells and/or individual beams. For example, the RS measurement can be an SSB measurement performed on a first RS 122 such as a first SSB beam burst on a first carrier frequency f1 within a first SMTC window 120a with a first SSB pattern. In some aspects, the RS measurement is configured by a measurement configuration. For example, the measurement configuration may specify one or more measurement types. The measurement configuration may be transmitted from the BS 111 to the UE 101 in a RRC message during the RRC connected state at 102.

In some aspects, the UE 101 may be configured to perform a measurement evaluation at act 108. The measurement evaluation may be used to evaluate if the RS measurement at act 106 is sufficient. In some aspects, the measurement evaluation may be based on UE needs or UE feedback. For example, the RS measurement at act 106 may be determined as insufficient, if measurements required by radio resource management of the BS 111 is not satisfied. As another example, if the UE 101 is with empty or low loads, the RS measurement at act 106 may be determined as sufficient by the measurement evaluation at act 108. However, when a more demanding service, such as a URLLC, arrives as shown by act 104, the latency requirement may not be satisfied when the UE 101 needs to wait for the long periodicity for next few SSBs to arrive. In this case, the RS measurement at act 106 may be determined as insufficient by the measurement evaluation at act 108.

In some additional aspects, the measurement evaluation at act 108 may be based on measurement results of the RS measurement at act 106. For example, if a value of the (pre)configured measurements satisfies a threshold value, which indicates degradation of the received RS by the UE 101, cell selection or reselection needs are imminent, and the RS measurement at act 106 may be determined as insufficient by the measurement evaluation at act 108.

In some additional aspect, the measurement evaluation at act 108 may be configured by the BS 111 through an RRC message such as a RRC reconfiguration. Alternatively or additionally, in some aspects, the measurement evaluation at act 108 may be configured by a broadcast signal such as a system information block (SIB). For example, the RRC message may configure the UE 101 to determine the RS measurement at act 106 as insufficient, if one or multiple following conditions or criteria is satisfied: 1) arrival of a selective set of logic channels with high priority, 2) establishment of a selective set of QoS flows; 3) establishment of a selective set of PDU sessions; 4) unsatisfactory of Packet Delay Budget (PDB) requirement by a measurement result; or 5) unsatisfactory assessment of a set of QoS characteristic parameters.

In one aspect, the set of QoS characteristic parameters may include a composite set of different parameters out of a set of QoS characteristics, such as Maximum Data Burst Volumn (MDBV), Packet Error Rate (PER), PDB, priority level, resource type, etc. In another aspect, the set of QoS characteristic parameters may be represented by a 5G QoS Identifier (5QI) or QoS Flow Identifier (QFI).

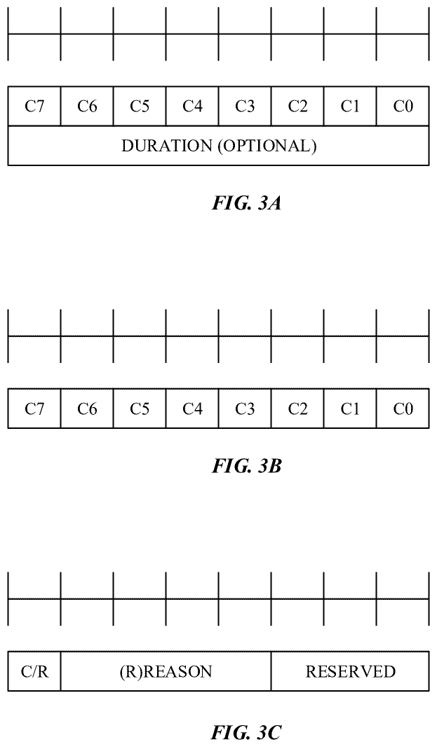

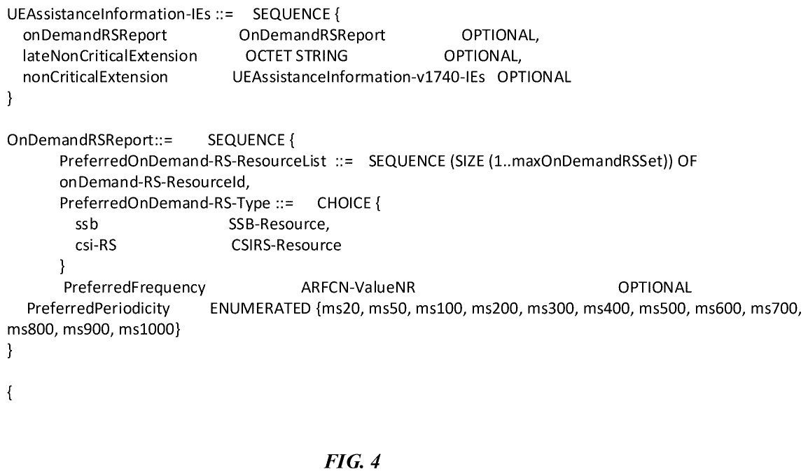

If the RS measurement at act 106 is determined as insufficient, in some aspects, the UE 101 transmits assistance information including an on-demand RS request or indication at act 110. The assistance information may be transmitted by the UE 101 to the BS 111 in several ways. In some aspects, the assistance information may be transmitted by UE Assistance Information (UAI) message. An example information element of the UAI will be described below associated with FIG. 4. In some alternative aspects, the assistance information may be transmitted by an on-demand RS request MAC Control Element (MAC-CE). An example format of the on-demand RS request MAC will be described below associated with FIG. 3A. In some further alternative aspects, the assistance information may be transmitted by a Layer 1 physical layer signaling, such as an uplink Wake-Up Signal (WUS).

In some aspects, the assistance information comprises information related to one or more parameters of an on-demand RS preferred by the UE 101, such as an RS type, an RS occurrence pattern, an RS duration, etc. The RS type may include SSB, Channel State Information Reference Signal (CSI-RS), Tracking Reference Signal (TRS), or the like. The RS occurrence pattern may comprise periodicity, frequency location, time location, beam pattern such as amount and width of the beams of the on-demand RS, or the like. In one aspect, the assistance information, transmitted through the UAI message or the on-demand RS request MAC-CE, may also specify a reporting duration such as N minutes or N number of periodicities the on-demand RS should be transmitted. The assistance information may report additional UE preference information such as if the UE 101 is willing to detect or measure on-demand RS based on, for example, conditions of the UE 101 such as a power state (e.g. low power, high power), a mobility (e.g. low or high speed mobility), etc., and how long the UE 101 is willing to report. The assistance information may additionally or alternatively include a preference indication of a set of RS indexes. Each of the set of RS indexes may correspond to a combination of one or more of an RS type, an RS occurrence pattern, and an RS duration. Thus, the UAI message or the RS request MAC-CE indicates UE preferred pattern, type, and/or duration of the on-demand RS.

In some further alternative aspects, the assistance information may be or be comprised of one indication bit or multiple indication bits indicating insufficient RS measurement at act 106. The indication bit(s) can be part of uplink control information (UCI) transmitted on physical uplink control channel (PUCCH) or can be included in the UAI message.

In some further embodiments, the assistance information may further comprise measurement results of the serving cell and/or the neighbor cells, even though the measurement is determined as insufficient at act 108. The BS 111 may use the assistance information to help determine whether to turn on or configure extra instances of the first RS or trigger new RS activations. In some aspects, the BS 111 may not adapt its transmission of RS even if the receiving of the assistance information from the UE 101 at act 110. The BS 111 may determine that the reported measurements are sufficient for subsequent actions and thus deny the on-demand RS request from the UE 101.

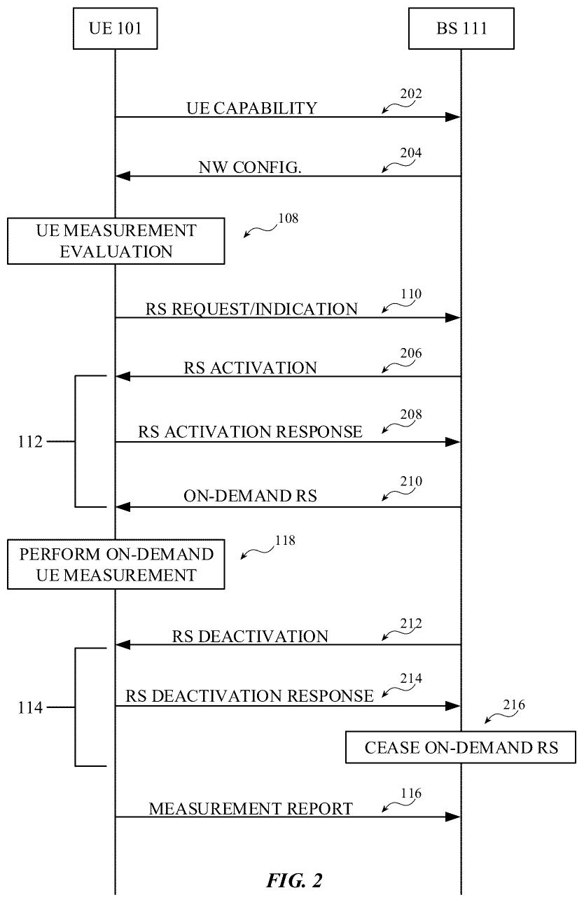

Upon receiving the on-demand RS request or indication at act 110, the BS 111 may dynamically add or adapt its RS transmission based on the received on-demand RS request. In some aspects, a second RS is activated at act 112 and then transmitted from the BS 111 to the UE 101. Signaling examples for the activation of the second RS at act 112 will be described below associated with FIG. 2 and FIGS. 3B-3C.

In some aspects, a hysteresis may be configured or otherwise defined to avoid frequent activation/deactivation at act 112. For example, the measurement evaluation at act 108 or other threshold-related requirements may be determined as satisfied or unsatisfied only when the measurement result exceeds a tolerance value A and/or longer than a predefined period of time. Alternatively or additionally, a prohibit timer is used to prevent too frequent status change. The prohibit timer could specify a minimum time and prohibit a subsequent status change within the specified minimum time immediately after a previous status change. For example, a prohibit timer could specify a minimum time between each reporting occasion (e.g. time between a first RS activation/deactivation and the next RS activation/deactivation). The prohibit timer may start on an occasion where the BS 111 activates or deactivates the second RS at act 112. The BS 111 may not change the activation/deactivation status again until the prohibit timer expires. Once the BS 111 activates or deactivates a second RS again at act 112, then the prohibit timer may be reset and the BS 111 may wait and not activate or deactivate another second RS until the prohibit timer expires again.

In response to the activation of the second RS at act 112, in some aspects, the BS 111 may adapt the first RS to the second RS with a new pattern such as increased periodicity, frequency, or amount of beams. For example, the BS 111 may adapt its transmission of SSBs based on the assistance information received from the UE 101 at act 110. For example, based on the assistance information, the BS 111 may adapt the transmission of SSBs to have shorter periodicity and/or more beams.

In some alternative aspects, the BS 111 may transmit the second RS as an on-demand RS in addition to the first RS. The second RS may be dedicated to the UE 101, and may be transmitted only on the beam the UE 101 selects for measurement. The BS 111 may communicate time and frequency locations of the second RS to the UE 101 through a dedicated RRC message. In one aspect, the second RS is transmitted on a frequency different than that of the first RS. In an alternative aspect, the second RS is transmitted on a frequency same as that of the first RS.

For example, the BS 111 may transmit a second RS 124 such as a second SSB burst with a second periodicity P2 smaller than the first periodicity P1 of the first RS 122 after receiving the on-demand RS request at act 110. The second RS 124 may be Non-CD SSBs transmitted on a second carrier frequency f2 different than the first carrier frequency f1 of the first RS 122 and may be transmitted within a second SMTC window 120b same or different from the first SMTC window 120a. The second RS 124 may comprise one or more SSB beams dedicated to the UE 101.

Alternately, the BS 111 may adapt to transmit an updated RS 122′ that may be CD SSBs not dedicated to the UE 101 and may be transmitted on the first carrier frequency f1. In this case, the updated RS 122′ may have a smaller periodicity P1′ than the first periodicity P1 of the first RS 122 and transmitted within an updated SMTC window 120a′ with a different pattern such as with more beams and/or shorter periodicity.

Though the example of increasing the number of beams and shortening the periodicity is given, the BS 111 may choose to increase or decrease the number of beams, increase or decrease beam width, and lengthen or shorten SSB periodicity individually, among other applicable pattern parameters, based on needs of the UE and/or network. By receiving assistance information to adapt SSB transmission, the BS 111 can save power by using more sparse reference signals during regular operation and only using more aggressive (i.e. higher energy consumption) transmission methods when needed.

When receiving the second RS, the UE 101 performs on-demand measurement on the second RS at act 118. The UE 101 may perform the on-demand measurement according to received measurement configuration. In some aspects, the on-demand measurement may be a cell RSRP, RSRQ, or SINR measurement. In some alternative or additional aspects, the on-demand measurement may also be a beam RSRP, RSRQ, or SINR measurement for one or more beams. Each beam measurement may have an associated beam index.

After completing the on-demand measurement on the second RS, in some aspects, the second RS is deactivated and ceased transmission at act 114. Signaling examples for the deactivation of the second RS at act 114 will be described below associated with FIG. 2 and FIGS. 3B-3C. A measurement report may be then transmitted from the BS 111 to the UE 101 at act 116 including measurement results on the second RS. In one aspect, the measurement report may be for the best beam available. In other aspects, the beam measurements include RSRP, RSRQ, or SINR values of the cell and/or beam(s) (e.g. each value individually, or any combination thereof) for the best N number of beams. The value N could be configured by BS 111 via an RRC Message or via SIB.

FIG. 2 is a schematic diagram illustrating signaling between the UE 101 and the BS 111 for on-demand RS measurement with additional or alternative details of FIG. 1 in accordance with some further aspects of the disclosure. As specified with more details below, in some aspects, while in the RRC connected state, the UE 101 and the BS 111 may exchange capability and preference information and/or network configuration information to schedule activation, detection, and measurement of an on-demand RS.

As shown by act 202, in some aspects, the UE 101 may send UE Capability Information to the BS 111. The UE Capability Information may include UE capability to detect or measure on-demand RS. The UE Capability Information may comprise a single bit indicating whether the UE 101 can detect or measure on-demand RS. The UE Capability Information may additionally or alternatively comprise multiple bits indicating capability to detect various different types of on-demand RS. For example, the multiple bits may comprise one or more bits indicating UE capability to measure on-demand Cell Defining SSB (CD-SSB), another one or more bits indicating UE capability to measure on-demand Non Cell Defining SSB (Non CD-SSB), another one or more bits indicating UE capability to measure CSI-RS, and/or another one or more bits indicating UE capability to measure TRS, etc. The UE 101 may additionally report preference information such as if the UE is willing to detect or measure on-demand RS based on, for example, conditions of the UE 101 such as battery level and how long the UE 101 is willing to report. In some aspect, the Capability Information is transmitted by the UE 101 in response to a UE Capability Enquiry received from the BS 111 while in an RRC connected state.

As shown by act 204, in some aspects, the BS 111 configures the UE 101 the on-demand RS through a network configuration information. The network configuration information may be transmitted by an RRC message such as an RRC reconfiguration. The network configuration information may configure a set of RS indexes, and each of the set of RS indexes may correspond to a combination of one or more of an RS type, an RS occurrence pattern, and an RS duration. The RS type may include CD-SSB, Non CD-SSB, CSI-RS, or TRS, etc. The RS occurrence pattern may include frequency and/or time location of the on-demand RS. The time-location may include periodicity and slot offset for a periodical transmission, such as defining SMTC window for SSB transmission. In some further aspects, the network configuration information may also specify how long the UE 101 shall report. For example, the network configuration information may specify a reporting duration of N minutes or N number of periodicities. The on-demand RS may be deactivated after the configured transmission length, such as after the reporting duration of N minutes or N number of periodicities. Thus, a semi-persistent transmission of the on-demand RS is configured.

In some further aspects, the network configuration information may further include a cell index if Carrier Aggregation (CA) is configured. The network configuration information could configure or reconfigure the UE 101 to continue the measurement and reporting after performing cell reselection (e.g. continue reporting assistance information on a neighboring cell). The cell index may indicate the neighboring cell that is capable of sending the on-demand RS.

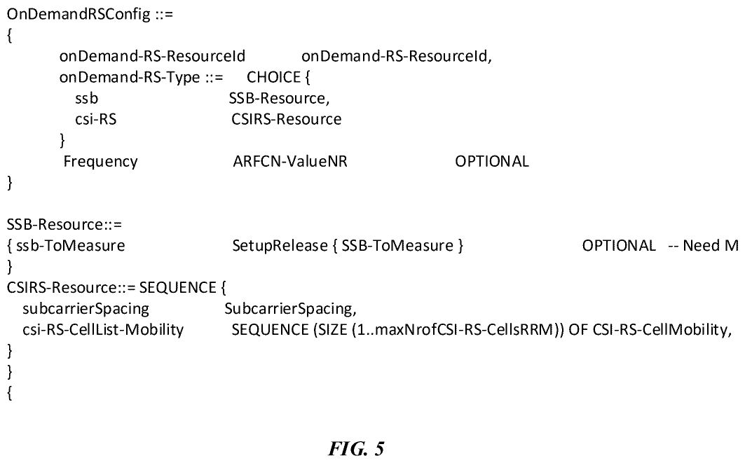

An example information element of the network configuration information will be described below associated with FIG. 5.

As shown by act 108 and act 110, in some aspects, the UE 101 may transmit assistance information to the BS 111 at act 110 based on an RS measurement evaluation at act 108. The UE 101 may indicate to the BS 111 that the current RS is insufficient, and thus request an on-demand RS. In some aspects, the measurement evaluation at act 108 may be based on the network configuration transmitted at act 204. The measurement evaluation at act 108 may be based on measurement results of the current RS measurement as well as UE capability, preference, and needs as discussed above.

As shown by act 112, in some aspects, an on-demand RS is activated and then transmitted from the BS 111 to the UE 101. The activation of the on-demand RS may be a two-way communication. Specifically, in response to the RS request received at act 110, the activation of the on-demand RS may comprise transmitting a downlink RS activation/deactivation MAC Control Element (MAC-CE) at act 206 from the BS 111 to the UE 101, indicating an on-demand RS activation. The downlink RS activation/deactivation MAC-CE may include a bit string with bits indicating activation/deactivation of RS associated with the set of RS indexes. An example of a downlink RS activation/deactivation MAC-CE is shown by FIG. 3B.

In response to the downlink RS activation/deactivation MAC Control Element (MAC-CE) at act 206, the UE 101 may transmit an uplink RS activation/deactivation response MAC-CE at act 208 to the BS 111. The uplink RS activation/deactivation response MAC-CE may include a bit string with one bit indicating confirmation or rejection of the RS activation/deactivation and one or more bits indicating a reason code if the rejection of RS activation/deactivation is indicated. If the BS 111 receives the confirmation of the RS activation/deactivation including an activation of an on-demand RS, the BS 111 transmits the on-demand RS at act 210. An example of an uplink RS activation/deactivation response MAC-CE is shown by FIG. 3C.

As shown by act 118, when receiving the on-demand RS, the UE 101 then performs on-demand measurement on the on-demand RS. After completing the on-demand measurement on the on-demand RS or a certain cease condition is satisfied, in some aspects, the on-demand RS is deactivated and ceased transmission at act 114. Similar to the activation of the on-demand RS as shown by act 112, in some aspects, the deactivation of the on-demand RS may also be a two-way communication. Specifically, after the completing the on-demand measurement or a condition is triggered to stop on-demand RS transmission, the deactivation of the on-demand RS may comprise transmitting a downlink RS activation/deactivation MAC Control Element (MAC-CE) at act 212 from the BS 111 to the UE 101, indicating an on-demand RS deactivation. The downlink RS activation/deactivation MAC-CE may include a bit string with bits indicating activation/deactivation of RS associated with the set of RS indexes. In some aspects, the downlink RS activation/deactivation MAC-CE deactivates the on-demand RS transmission after the configured transmission length, such as after the specified reporting duration of N minutes or N number of periodicities. The BS 111 may also optionally deactivate the on-demand RS early before the configured transmission length using the downlink RS activation/deactivation MAC-CE. An example of a downlink RS activation/deactivation MAC-CE is shown by FIG. 3B.

In response to the downlink RS activation/deactivation MAC Control Element (MAC-CE) at act 212, the UE 101 may transmit an uplink RS activation/deactivation response MAC-CE at act 214 to the BS 111. The uplink RS activation/deactivation response MAC-CE may include a bit string with one bit indicating confirmation or rejection of the RS activation/deactivation and one or more bits indicating a reason code if the rejection of RS activation/deactivation is indicated. If the BS 111 receives the confirmation of the RS activation/deactivation including a deactivation of an on-demand RS, the BS 111 ceases the on-demand RS at act 216. An example of an uplink RS activation/deactivation response MAC-CE is shown by FIG. 3C.

As shown by act 116, a measurement report may be then transmitted from the UE 101 to the BS 111 including measurement results on the on-demand RS.

FIGS. 3A-3C are schematic diagrams illustrating RS related MAC-CEs in accordance with some aspects of the disclosure. As shown in FIG. 3A, in some aspects, an RS assistance information may be transmitted by an on-demand RS request MAC Control Element (MAC-CE). The on-demand RS request MAC-CE may be transmitted by an uplink physical channel such as Physical Uplink Shared Channel (PUSCH). In one aspect, the RS request MAC-CE includes a bit string with bits indicating UE preference of RS associated with a set of RS indexes. Each bit may correspond to an activation or deactivation indication of an RS index of the set of RS indexes. The RS indexes may be configured by a network configuration information such as an RRC message. The RS indexes may respectively represent a combination of one or more of an RS type, an RS occurrence pattern, and an RS duration. The on-demand RS request MAC-CE may optionally further include duration information of a time length or number of periodicities, if such duration information is not included in the RS indexes. The duration information may be used to achieve a semi-persistent transmission of the on-demand RS.

As shown in FIG. 3B, in some aspects, a downlink RS activation/deactivation MAC-CE is transmitted from the BS to the UE indicating an on-demand RS activation or deactivation. The downlink RS activation/deactivation MAC-CE may be transmitted by a downlink physical channel such as Physical Downlink Shared Channel (PDSCH). The downlink RS activation/deactivation MAC-CE may include a bit string with bits indicating activation/deactivation of RS associated with the set of RS indexes.

As shown in FIG. 3C, in some aspects, an uplink RS activation/deactivation response MAC-CE may be transmitted from the UE to the BS, in response to the downlink RS activation/deactivation MAC-CE. The uplink RS activation/deactivation response MAC-CE may include a bit string with one bit indicating confirmation or rejection of RS activation/deactivation and one or more bits indicating a reason code if the rejection of RS activation/deactivation is indicated.

FIG. 4 is a diagram illustrating an example of an RS request information element in accordance with some aspects of the disclosure. As shown in FIG. 4, in some aspect, the RS request can be included in an information element (IE) of the UAI message. In some aspects, the UAI IE may comprise information related to one or more parameters of an on-demand RS preferred by the UE 101, such as UE preferred on-demand RS type, preferred resources, preferred frequency, and/or periodicity. The UE preferred on-demand RS type may include a choice among SSB, CSI-RS, TRS, or the like. Resources corresponding to each preferred on-demand RS type may also be provided. The preferred resources may be included as a list of RS resource set with resource identity referenced. The resource identity may be mapped to time and frequency location of a respective resource. The preferred frequency may be referred by one or more values of an absolute radio-frequency channel number (ARFCN). The preferred periodicity may be indicated by a plurality of enumerated values representing time or number of periodicities the on-demand RS should be transmitted. An example of the enumerated values of the preferred periodicity can be 20 ms, 50 ms, 100 ms, 200 ms, 300 ms, 400 ms, 500 ms, 600 ms, 700 ms, 800 ms, 700 ms, and 1000 ms.

FIG. 5 is a diagram illustrating an example of an on-demand RS configuration IE used to configure a UE an on-demand RS through a network configuration information in accordance with some aspects of the disclosure. As shown in FIG. 5, the on-demand RS configuration IE may comprise information related to one or more parameters of an on-demand RS configuration, such as on-demand RS type, RS resources, RS transmission frequency, and/or periodicity. The on-demand RS type may include a choice among SSB, CSI-RS, TRS, or the like. Resources corresponding to each on-demand RS type may also be provided. The resources may be included as a list of RS resource set with resource identity referenced. The resource identity may be mapped to time and frequency location of a respective resource as well as other relevant parameters such as subcarrier spacing or cell mobility. The RS transmission frequency may be referred by one or more values of an absolute radio-frequency channel number (ARFCN). The periodicity may be indicated by a plurality of enumerated values representing time or number of periodicities the on-demand RS should be transmitted.

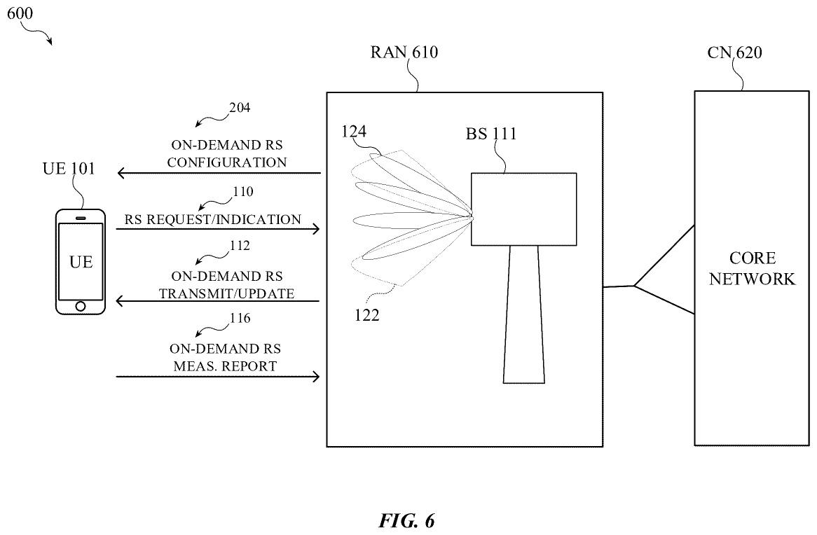

FIG. 6 is a block diagram illustrating a wireless network 600 including a UE 101 and a BS 111 for on-demand RS measurement based on an RS request from the UE 101 in accordance with some aspects of the disclosure. The features discussed throughout the disclosure can be incorporated in the wireless network 600. The following description is provided for an example system that operates in conjunction with the 5G or NR system standards as provided by 3GPP technical specifications. However, the example aspects are not limited in this regard and the described aspects may apply to other networks that benefit from the principles described herein, such as future 3GPP systems (e.g., Sixth Generation (6G)) systems, IEEE 702.16 protocols (e.g., WMAN, WiMAX, etc.), or the like.

In this example shown by FIG. 6, the UE 101 is illustrated as a smartphone (e.g., a handheld touchscreen mobile computing device connectable to one or more cellular networks), but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The UE 101 can be configured to connect, for example, communicatively couple, with a Radio Access Network (RAN) 610. The RAN 610 may comprise one or more BSs 111. In some aspects, the RAN 610 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 610 that operates in an NR or 5G system, and the term “E-UTRAN” or the like can refer to a RAN 610 that operates in an LTE or 4G system. According to various aspects, the RAN 610 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

The UE 101 may utilize connections (or channels) comprising a physical communications interface/layer for downlink and uplink respectively. In this example, the connections are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein.

In some aspects, the BS 111 may utilize downlink connection to transmit on-demand RS configuration at act 204 and transmit on-demand RS activation/deactivation at act 112, 114 as discussed in this disclosure in detail. The UE 101 may utilize uplink connection to provide RS request or indication at act 110 and provide measurement report at act 116 as discussed in this disclosure in detail. In some aspects, in response to the RS request or indication and after establishing an on-demand RS activation, the BS 111 may perform an additional or adapted RS pattern. Depending on the needs of the UE 101 and the determination of the BS 111, the BS 111 may provide a dedicated on-demand RS 124 to the UE 101 or adapt its current RS 122 to be more aggressive, if a low latency or otherwise more demanding service is needed. As an example, performing a SSB pattern update may include adding or changing the SSB number of beams, width of the SSB beams, and/or periodicity of the SSB transmission.

The RAN 610 is shown to be communicatively coupled to a core network-in this aspect, core network (CN) 620. The CN 620 may comprise a plurality of network elements configured to offer various data and telecommunications services to customers/subscribers (e.g., users of the UE 101) who are connected to the CN 620 via the RAN 610. The components of the CN 620 may be implemented in one physical node or separate physical nodes including components to read and execute instructions from a machine-readable or computer-readable medium (e.g., a non-transitory machine-readable storage medium). In some aspects, NFV may be utilized to virtualize any or all of the above-described network node functions via executable instructions stored in one or more computer-readable storage mediums (described in further detail below). A logical instantiation of the CN 620 may be referred to as a network slice, and a logical instantiation of a portion of the CN 620 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

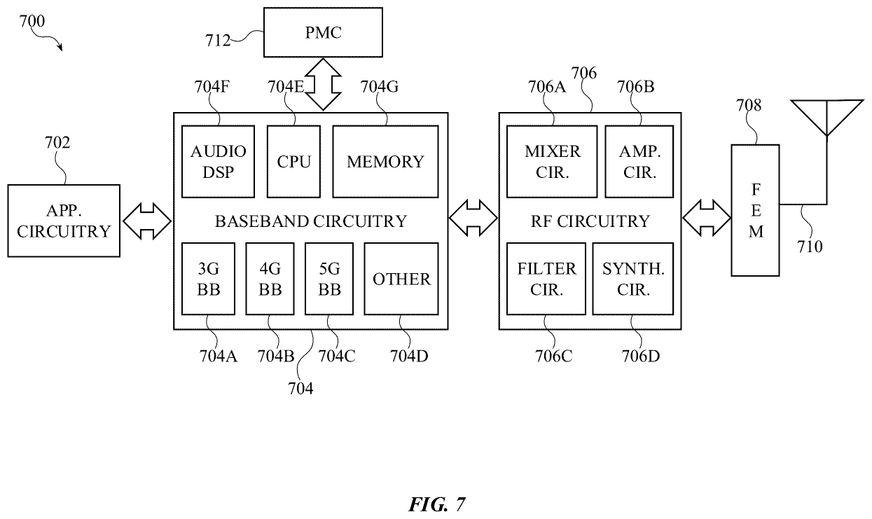

FIG. 7 is a diagram illustrating example components of a device 700 that can be employed in accordance with some aspects. In some aspects, the device 700 can include application circuitry 702, baseband circuitry 704, Radio Frequency (RF) circuitry 706, front-end module (FEM) circuitry 708, one or more antennas 710, and power management circuitry (PMC) 712 coupled together at least as shown. The components of the illustrated device 700 can be included in a UE or a RAN node such as the UE 101 or the BS 111 as described throughout this disclosure. In some implementations, the device 700 can include fewer elements (e.g., a RAN node may not utilize application circuitry 702 and instead include a processor/controller to process IP data received from a core network (CN), which may be a 5GC or an Evolved Packet Core (EPC)). In some implementations, the device 700 can include additional elements such as, for example, memory/storage, display, camera, sensor (including one or more temperature sensors, such as a single temperature sensor, a plurality of temperature sensors at different locations in device 700, etc.), or input/output (I/O) interface. In other implementations, the components described below can be included in more than one device (e.g., said circuitries can be separately included in more than one device for Cloud-RAN (C-RAN) implementations).

The application circuitry 702 can include one or more application processors. For example, the application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 700. In some implementations, processors of application circuitry 702 can process IP data packets received from an EPC.

The baseband circuitry 704 can include circuitry such as, but not limited to, one or more single-core or multi-core processors. The baseband circuitry 704 can include one or more baseband processors or control logic to process baseband signals received from a receive signal path of the RF circuitry 706 and to generate baseband signals for a transmit signal path of the RF circuitry 706. The baseband circuitry 704, or the one or more baseband processors or control logic of the baseband circuitry 704, may stand alone as the UE 101 or the BS 111 and perform signaling and operation in the meaning as described throughout this disclosure. The baseband circuitry 704 can interface with the application circuitry 702 for generation and processing of the baseband signals and for controlling operations of the RF circuitry 706. For example, in some implementations, the baseband circuitry 704 can include a third generation (3G) baseband processor 704A, a fourth generation (4G) baseband processor 704B, a fifth generation (5G) baseband processor 704C, or other baseband processor(s) 704D for other existing generations, generations in development or to be developed in the future (e.g., second generation (2G), sixth generation (6G), etc.). The baseband circuitry 704 (e.g., one or more of baseband processors 704A-D) can handle various radio control functions that enable communication with one or more radio networks via the RF circuitry 706. In other implementations, some or all of the functionality of baseband processors 704A-D can be included in modules stored in the memory 704G and executed via a Central Processing Unit (CPU) 704E. The radio control functions can include but are not limited to signal modulation/demodulation, encoding/decoding, radio frequency shifting, etc. In some implementations, modulation/demodulation circuitry of the baseband circuitry 704 can include Fast-Fourier Transform (FFT), precoding, or constellation mapping/demapping functionality. In some implementations, encoding/decoding circuitry of the baseband circuitry 704 can include convolution, tail-biting convolution, turbo, Viterbi, or Low Density Parity Check (LDPC) encoder/decoder functionality. Implementations of modulation/demodulation and encoder/decoder functionality are not limited to these examples and can include other suitable functionality in other implementations.

In some implementations, the baseband circuitry 704 can include one or more audio digital signal processor(s) (DSP) 704F. The audio DSP(s) 704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 704 and the application circuitry 702 can be implemented together such as, for example, on a system on a chip (SOC).

In some implementations, the baseband circuitry 704 can provide for communication compatible with one or more radio technologies. For example, in some implementations, the baseband circuitry 704 can support communication with an NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various implementations, the RF circuitry 706 can include switches, filters, amplifiers, etc., to facilitate communication with the wireless network. RF circuitry 706 can include a receive signal path which can include circuitry to down-convert RF signals received from the FEM circuitry 708 and provide baseband signals to the baseband circuitry 704. RF circuitry 706 can also include a transmit signal path which can include circuitry to up-convert baseband signals provided by the baseband circuitry 704 and provide RF output signals to the FEM circuitry 708 for transmission.

In some implementations, the receive signal path of the RF circuitry 706 can include mixer circuitry 706a, amplifier circuitry 706b, and filter circuitry 706c. In some implementations, the transmit signal path of the RF circuitry 706 can include filter circuitry 706c and mixer circuitry 706a. RF circuitry 706 can also include synthesizer circuitry 706d for synthesizing a frequency for use by the mixer circuitry 706a of the receive signal path and the transmit signal path. In some implementations, the mixer circuitry 706a of the receive signal path can be configured to down-convert RF signals received from the FEM circuitry 708 based on the synthesized frequency provided by synthesizer circuitry 706d. The amplifier circuitry 706b can be configured to amplify the down-converted signals, and the filter circuitry 706c can be a low-pass filter (LPF) or band-pass filter (BPF) configured to remove unwanted signals from the down-converted signals to generate output baseband signals. Output baseband signals can be provided to the baseband circuitry 704 for further processing. In some implementations, the output baseband signals can be zero-frequency baseband signals, although this is not a requirement. In some implementations, mixer circuitry 706a of the receive signal path can comprise passive mixers, although the scope of the implementations is not limited in this respect.

In some implementations, the mixer circuitry 706a of the transmit signal path can be configured to up-convert input baseband signals based on the synthesized frequency provided by the synthesizer circuitry 706d to generate RF output signals for the FEM circuitry 708. The baseband signals can be provided by the baseband circuitry 704 and can be filtered by filter circuitry 706c.

In some implementations, the mixer circuitry 706a of the receive signal path and the mixer circuitry 706a of the transmit signal path can include two or more mixers and can be arranged for quadrature downconversion and upconversion, respectively. In some implementations, the mixer circuitry 706a of the receive signal path and the mixer circuitry 706a of the transmit signal path can include two or more mixers and can be arranged for image rejection (e.g., Hartley image rejection). In some implementations, the mixer circuitry 706a of the receive signal path and the mixer circuitry 706a can be arranged for direct downconversion and direct upconversion, respectively. In some implementations, the mixer circuitry 706a of the receive signal path and the mixer circuitry 706a of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 706 can include analog-to-digital converter (ADC) and digital-to-analog converter (DAC) circuitry, and the baseband circuitry 704 can include a digital baseband interface to communicate with the RF circuitry 706.

In some dual-mode implementations, a separate radio IC circuitry can be provided for processing signals for each spectrum, although the scope of the implementations is not limited in this respect.

In some implementations, the synthesizer circuitry 706d can be a fractional-N synthesizer or a fractional N/N+1 synthesizer, although the scope of the implementations is not limited in this respect as other types of frequency synthesizers can be suitable. For example, synthesizer circuitry 706d can be a delta-sigma synthesizer, a frequency multiplier, or a synthesizer comprising a phase-locked loop with a frequency divider.

The synthesizer circuitry 706d can be configured to synthesize an output frequency for use by the mixer circuitry 706a of the RF circuitry 706 based on a frequency input and a divider control input. In some implementations, the synthesizer circuitry 706d can be a fractional N/N+1 synthesizer.

FEM circuitry 708 can include a receive signal path which can include circuitry configured to operate on RF signals received from one or more antennas 710, amplify the received signals and provide the amplified versions of the received signals to the RF circuitry 706 for further processing. FEM circuitry 708 can also include a transmit signal path which can include circuitry configured to amplify signals for transmission provided by the RF circuitry 706 for transmission by one or more of the one or more antennas 710. In various implementations, the amplification through the transmit or receive signal paths can be done solely in the RF circuitry 706, solely in the FEM circuitry 708, or in both the RF circuitry 706 and the FEM circuitry 708.

In some implementations, the FEM circuitry 708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 706). The transmit signal path of the FEM circuitry 708 can include a power amplifier (PA) to amplify input RF signals (e.g., provided by RF circuitry 706), and one or more filters to generate RF signals for subsequent transmission (e.g., by one or more of the one or more antennas 710).

In some implementations, the PMC 712 can manage power provided to the baseband circuitry 704. In particular, the PMC 712 can control power-source selection, voltage scaling, battery charging, or DC-to-DC conversion. The PMC 712 can often be included when the device 700 is capable of being powered by a battery, for example, when the device is included in a UE. The PMC 712 can increase the power conversion efficiency while providing desirable implementation size and heat dissipation characteristics.

While FIG. 7 shows the PMC 712 coupled only with the baseband circuitry 704. However, in other implementations, the PMC 712 may be additionally or alternatively coupled with, and perform similar power management operations for, other components such as, but not limited to, application circuitry 702, RF circuitry 706, or FEM circuitry 708.

In some implementations, the PMC 712 can control, or otherwise be part of, various power saving mechanisms of the device 700. For example, if the device 700 is in an RRC_Connected state, where it is still connected to the RAN node as it expects to receive traffic shortly, then it can enter a state known as Discontinuous Reception Mode (DRX) after a period of inactivity. During this state, the device 700 can power down for brief intervals of time and thus save power.

If there is no data traffic activity for an extended period of time, then the device 700 can transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 702 and processors of the baseband circuitry 704 can be used to execute elements of one or more instances of a protocol stack. For example, processors of the baseband circuitry 704, alone or in combination, can be used execute Layer 3, Layer 2, or Layer 1 functionality, while processors of the baseband circuitry 704 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer. As referred to herein, Layer 2 can comprise a medium access control (MAC) layer, a radio link control (RLC) layer, and a packet data convergence protocol (PDCP) layer. As referred to herein, Layer 1 can comprise a physical (PHY) layer of a UE/RAN node.

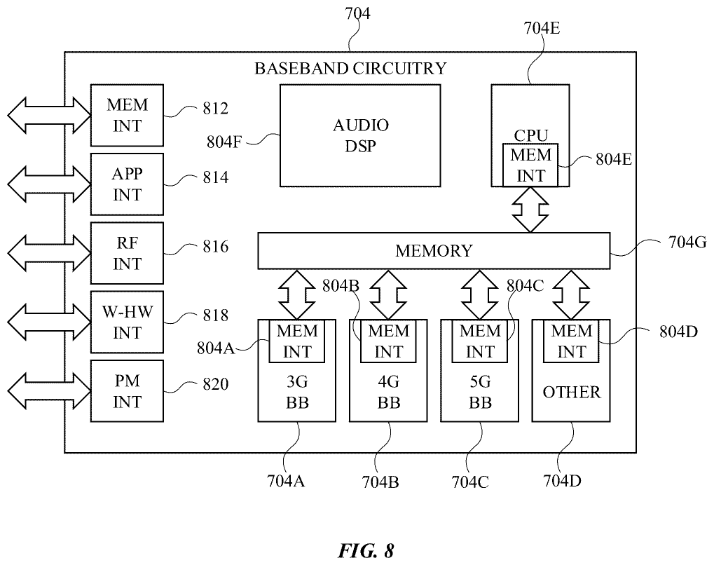

FIG. 8 illustrates a diagram illustrating example interfaces of baseband circuitry that can be employed in accordance with some aspects. As discussed above, the baseband circuitry 704 of FIG. 7 can comprise processors 704A-704E and a memory 704G utilized by said processors. Each of the processors 704A-704E can include a memory interface, 804A-804E, respectively, to send/receive data to/from the memory 704G.

The baseband circuitry 704 can further include one or more interfaces to communicatively couple to other circuitries/devices, such as a memory interface 812 (e.g., an interface to send/receive data to/from memory external to the baseband circuitry 704), an application circuitry interface 814 (e.g., an interface to send/receive data to/from the application circuitry 702 of FIG. 7), an RF circuitry interface 816 (e.g., an interface to send/receive data to/from RF circuitry 706 of FIG. 7), a wireless hardware connectivity interface 818 (e.g., an interface to send/receive data to/from Near Field Communication (NFC) components, Bluetooth® components (e.g., Bluetooth® Low Energy), Wi-Fi® components, and other communication components), and a power management interface 820 (e.g., an interface to send/receive power or control signals to/from the PMC 712).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus of a user equipment (UE), the UE comprising one or more processors configured to perform a Reference Signal (RS) measurement using a first RS received from a Base Station (BS); determine whether the RS measurement is sufficient; in a Radio Resource Control (RRC) connected state, transmit an RS request to the BS to request a second RS if the RS measurement of the first RS is determined as insufficient; receive the second RS from the BS; and perform a measurement using the second RS.

Example 2 comprises the subject matter of any variation of any of example(s) 1, wherein the RS request is transmitted by a UE Assistance Information (UAI) message.

Example 3 comprises the subject matter of any variation of any of example(s) 1, wherein the RS request is transmitted by an RS request MAC Control Element (MAC-CE).

Example 4 comprises the subject matter of any variation of any of example(s) 2 or claim 3, wherein the one or more processors further configured to receive a network configuration information through an RRC message. The network configuration information comprises a set of RS indexes each corresponding to a combination of one or more of a RS type, an RS occurrence pattern, and a RS duration. Through a preference indication of each of the set of RS indexes, the UAI message or the RS request MAC-CE indicates UE preferred pattern, type, and/or duration of the second RS.

Example 5 comprises the subject matter of any variation of any of example(s) 4, wherein the network configuration information further includes a cell index if Carrier Aggregation (CA) is configured, the cell index indicating a cell that sends the second RS.

Example 6 comprises the subject matter of any variation of any of example(s) 4, wherein the one or more processors are further configured to receive an RS activation/deactivation MAC Control Element (MAC-CE) in response to the RS request or after the measurement using the second RS. The RS activation/deactivation MAC-CE includes a bit string with bits indicating activation/deactivation of RS associated with the set of RS indexes.

Example 7 comprises the subject matter of any variation of any of example(s) 6, wherein the one or more processors are further configured to transmit an RS activation/deactivation response MAC-CE to the BS after receiving the RS activation/deactivation MAC-CE from the BS. The RS activation/deactivation response MAC-CE includes a bit string with one bit indicating confirmation or rejection of RS activation/deactivation and one or more bits indicating a reason code if the rejection of RS activation/deactivation is indicated.

Example 8 comprises the subject matter of any variation of any of example(s) 1, wherein the RS request is transmitted by a physical layer signaling.

Example 9 comprises the subject matter of any variation of any of example(s) 1, wherein the RS request is transmitted to the BS as one bit payload of Uplink Control Information (UCI) carried by PUCCH or UE Assistance information (UAI) message to indicate the (pre)configured RS measurement being determined as insufficient.

Example 10 comprises the subject matter of any variation of any of example(s) 1, wherein the RS request comprises one or more of a pattern of the second RS, a type of the second RS, and a duration of the second RS.

Example 11 comprises the subject matter of any variation of any of example(s) 1, wherein the second RS is a cell defining Synchronization Signal Block (SSB) signal, a non cell defining SSB signal, a Channel State Information Reference Signal (CSI-RS), or a Tracking Reference Signal (TRS).

Example 12 comprises the subject matter of any variation of any of example(s) 1, wherein the RS measurement is determined as insufficient if measurements required by radio resource management of the BS is not satisfied.

Example 13 comprises the subject matter of any variation of any of example(s) 12, wherein the RS request is transmitted to the BS if one or more of the following conditions are configured by the BS through an RRC message: arrival of a selective set of logic channels with high priority, establishment of a selective set of QoS flows or PDU sessions, comparison of measurement results with Packet Delay Budget (PDB) requirement, or comparison of a set of QoS characteristic parameters with thresholds.

Example 14 comprises the subject matter of any variation of any of example(s) 1, wherein a hysteresis or a prohibit timer is configured to avoid frequent transmission of the RS request.

Example 15 comprises the subject matter of any variation of any of example(s) 1, wherein the second RS is transmitted on a frequency different than that of the first RS; and wherein time and frequency location of the second RS is communicated to the UE through a dedicated RRC message.

Example 16 comprises the subject matter of any variation of any of example(s) 1, wherein the second RS is transmitted on a frequency same as that of the first RS. A time location of the second RS is communicated to the UE through a dedicated RRC message.

Example 17 comprises the subject matter of any variation of any of example(s) 1, wherein periodicity and slot offset of the second RS are configured by an RRC message, and the second RS is activated and deactivated by an RS activation/deactivation MAC-CE.

Example 18 comprises the subject matter of any variation of any of example(s) 1, wherein periodicity and slot offset of the second RS are configured by an RRC message, and a duration of the second RS is configured by the RRC message or included in an RS request MAC-CE.

Example 19 is an apparatus of a Base Station (BS), the BS comprising one or more processors configured to: transmit a first Reference Signal (RS) to a User Equipment (UE) for the UE to perform an RS measurement; receive an RS request from the UE requesting a second RS; and transmit the second RS to the UE upon receiving the RS request.

Example 20 comprises the subject matter of any variation of any of example(s) 19, wherein the RS request is received through a UE Assistance Information (UAI) message.

Example 21 comprises the subject matter of any variation of any of example(s) 1, wherein the RS request is received through an RS request MAC Control Element (MAC-CE).

Example 22 comprises the subject matter of any variation of any of example(s) 20 or 21, wherein the one or more processors further configured to: transmit a network configuration information through an RRC message. The network configuration information comprises a set of RS indexes each corresponding to a combination of one or more of a RS type, an RS occurrence pattern, and a RS duration. The UAI message or the RS request MAC-CE indicates UE preferred pattern, type, and duration of the second RS through a preference indication of each of the set of RS indexes.

Example 23 is a method to be performed by a user equipment (UE), the method comprising: receiving a network configuration information through an RRC message, wherein the network configuration information comprises a set of RS indexes each corresponding to a combination of one or more of a RS type, an RS occurrence pattern, and a RS duration; performing a Reference Signal (RS) measurement using a first RS received from a Base Station (BS); determining whether the RS measurement is sufficient; transmitting an RS request to the BS to request a second RS associated with one of the set of RS indexes, if the RS measurement is determined as insufficient; receiving the second RS from the BS; and performing a measurement using the second RS.

Example 24 comprises the subject matter of any variation of any of example(s) 23, wherein the RS request is transmitted by an RS request MAC Control Element (MAC-CE), the RS request MAC-CE includes a bit string with bits indicating preference of RS associated with the set of RS indexes.

Example 25 comprises the subject matter of any variation of any of example(s) 23, and further comprising receiving an RS activation/deactivation MAC Control Element (MAC-CE) upon transmitting the RS request and after the receiving of the second RS, the RS activation/deactivation MAC-CE includes a bit string with bits indicating activation or deactivation of RS associated with the set of RS indexes.

Example 26 comprises the subject matter of any variation of any of example(s) 23, and further comprising: transmitting an RS activation/deactivation response MAC-CE after receiving the RS activation/deactivation MAC-CE. The RS activation/deactivation response MAC-CE includes a bit string with one bit indicating confirmation or rejection of the activation or deactivation of RS and one or more bits indicating a reason code if the rejection of RS activation/deactivation is indicated.

Example 27 is a method that includes any action or combination of actions as substantially described herein in the Detailed Description.

Example 28 is a method as substantially described herein with reference to each or any combination of the Figures included herein or with reference to each or any combination of paragraphs in the Detailed Description.

Example 29 is a user equipment configured to perform any action or combination of actions as substantially described herein in the Detailed Description as included in the user equipment.

Example 30 is a network node configured to perform any action or combination of actions as substantially described herein in the Detailed Description as included in the network node.

Example 31 is a non-volatile computer-readable medium that stores instructions that, when executed, cause the performance of any action or combination of actions as substantially described herein in the Detailed Description.

Example 32 is a baseband processor of a user equipment configured to perform any action or combination of actions as substantially described herein in the Detailed Description as included in the user equipment.

Example 33 is a baseband processor of a network node configured to perform any action or combination of actions as substantially described herein in the Detailed Description as included in the user equipment.

Example 34 includes a product comprising one or more tangible computer-readable non-transitory storage media comprising computer-executable instructions operable to, when executed by at least one computer processor, enable the at least one processor to perform the method of any one of the Examples above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An apparatus for a User Equipment (UE), comprising
one or more processors configured to:
perform a Reference Signal (RS) measurement using a first RS received from a Base Station (BS);
determine whether the RS measurement is sufficient;
in a Radio Resource Control (RRC) connected state, transmit an RS request to the BS to request a second RS if the RS measurement of the first RS is determined as insufficient;
receive the second RS from the BS; and
perform a measurement using the second RS.

2. The apparatus of claim 1, wherein the RS request is transmitted by a UE Assistance Information (UAI) message, or an RS request MAC Control Element (MAC-CE).

3. (canceled)

4. The apparatus of claim 2, wherein the one or more processors further configured to:
receive a network configuration information through an RRC message;
wherein the network configuration information comprises a set of RS indexes each corresponding to a combination of one or more of a RS type, an RS occurrence pattern, and a RS duration; and
wherein, through a preference indication of each of the set of RS indexes, the UAI message or the RS request MAC-CE indicates UE preferred pattern, type, and/or duration of the second RS.

5. The apparatus of claim 4, wherein the network configuration information further includes a cell index if Carrier Aggregation (CA) is configured, the cell index indicating a cell that sends the second RS.

6. The apparatus of claim 4, wherein the one or more processors are further configured to:
receive an RS activation/deactivation MAC Control Element (MAC-CE) in response to the RS request or after the measurement using the second RS; and
wherein the RS activation/deactivation MAC-CE includes a bit string with bits indicating activation/deactivation of RS associated with the set of RS indexes.

7. The apparatus of claim 6, wherein the one or more processors are further configured to:
transmit an RS activation/deactivation response MAC-CE to the BS after receiving the RS activation/deactivation MAC-CE from the BS; and
wherein the RS activation/deactivation response MAC-CE includes a bit string with one bit indicating confirmation or rejection of RS activation/deactivation and one or more bits indicating a reason code if the rejection of RS activation/deactivation is indicated.

8. The apparatus of claim 1, wherein the RS request is transmitted by a physical layer signaling.

9. The apparatus of claim 1, wherein the RS request is transmitted to the BS as one bit payload of Uplink Control Information (UCI) carried by PUCCH or UE Assistance information (UAI) message to indicate the (pre)configured RS measurement being determined as insufficient.

10. The apparatus of claim 1, wherein the RS request comprises one or more of a pattern of the second RS, a type of the second RS, and a duration of the second RS.

11. The apparatus of claim 1, wherein the second RS is a cell defining Synchronization Signal Block (SSB) signal, a non cell defining SSB signal, a Channel State Information Reference Signal (CSI-RS), or a Tracking Reference Signal (TRS).

12. The apparatus of claim 1, wherein the RS measurement is determined as insufficient if measurements required by radio resource management of the BS is not satisfied.

13. The apparatus of claim 12, wherein the RS request is transmitted to the BS if one or more of the following conditions are configured by the BS through an RRC message:
arrival of a selective set of logic channels with high priority,
establishment of a selective set of QoS flows or PDU sessions,
comparison of measurement results with Packet Delay Budget (PDB) requirement, or
comparison of a set of QoS characteristic parameters with thresholds.

14. The apparatus of claim 1, wherein a hysteresis or a prohibit timer is configured to avoid frequent transmission of the RS request.

15. The apparatus of claim 1,
wherein the second RS is transmitted on a frequency different than that of the first RS; and
wherein time and frequency location of the second RS is communicated to the UE through a dedicated RRC message.

16. The apparatus of claim 1,
wherein the second RS is transmitted on a frequency same as that of the first RS; and
wherein a time location of the second RS is communicated to the UE through a dedicated RRC message.

17. The apparatus of claim 1, wherein periodicity and slot offset of the second RS are configured by an RRC message, and the second RS is activated and deactivated by an RS activation/deactivation MAC-CE.

18. The apparatus of claim 1, wherein periodicity and slot offset of the second RS are configured by an RRC message, and a duration of the second RS is configured by the RRC message or included in an RS request MAC-CE.

19. An apparatus for a Base Station (BS), comprising
one or more processors configured to:
transmit a first Reference Signal (RS) to a User Equipment (UE) for the UE to perform an RS measurement; and
receive an RS request from the UE requesting a second RS; and
transmit the second RS to the UE upon receiving the RS request.

20-22. (canceled)

23. A method to be performed by a user equipment (UE), comprising:
receiving a network configuration information through an RRC message, wherein the network configuration information comprises a set of RS indexes each corresponding to a combination of one or more of a RS type, an RS occurrence pattern, and a RS duration;
performing a Reference Signal (RS) measurement using a first RS received from a Base Station (BS);
determining whether the RS measurement is sufficient;
transmitting an RS request to the BS to request a second RS associated with one of the set of RS indexes, if the RS measurement is determined as insufficient;
receiving the second RS from the BS; and
performing a measurement using the second RS.

24. The method of claim 23, wherein the RS request is transmitted by an RS request MAC Control Element (MAC-CE), the RS request MAC-CE includes a bit string with bits indicating preference of RS associated with the set of RS indexes.

25-26. (canceled)
